(19) United States
(12) Patent Application Publication
(10) Pub. No.: US 2012/0019227 A1
(43) Pub. Date: Jan. 26, 2012

(54) POWER SUPPLY CIRCUIT

(75) Inventors: Chun Kiong Leslie KHOO, Singapore (SG); Ulysses Ramos LOPEZ, Singapore (SG); Gin Kooi LIM, Singapore (SG); Toru MATSUNAGA, Singapore (SG)

(73) Assignees: PANASONIC SEMICONDUCTOR ASIA PTE., LTD., Singapore (SG); PANASONIC CORPORATION, Osaka (JP)

(21) Appl. No.: 12/842,408

(22) Filed: Jul. 23, 2010

(51) Int. Cl. G05F 5/00

(52) U.S. Cl. 323/299

(57) ABSTRACT

An apparatus for selecting either a High VIN path or a Low VIN path from a voltage source to a low voltage circuit is disclosed. The apparatus has a clamped step down circuit operable to select the High VIN path when a voltage level from the voltage source is above or equal to a pre-determined voltage level and, a power supply control circuit operable to select the Low VIN path when the voltage level from the voltage source is below the pre-determined voltage level.

### FIELD OF THE INVENTION

The present invention relates to a power supply circuit and, more particularly, to a control circuit for supplying power to a low-power semiconductor integrated circuit devices that possesses a large input dynamic range. Typical field of applications comprise of LED Management systems and Power Management systems.

### BACKGROUND OF THE INVENTION

For typical applications such as in LED Management systems and Power Management systems, the power supply voltage requirements may vary due to varying power usage intensities in different applications. For the purpose of explanation of this invention, the power supply voltage requirements may be in the range of typically 3V to 20V. Various methods are available to meet this requirement.

One method is described in US7,531,996 which discloses a low dropout (LDO) regulator with wide input voltage range, as shown in FIG. 1. The LDO utilizes two parallel-arranged pass transistors in the form of an N-type pass transistor 31 and a P-type pass transistor 32 to supply power to the output terminal. The gate terminals of these pass transistors are further controlled by a pair of error amplifiers to generate the first and second output voltages. These first and second output voltages are generated when the input voltage V_{IN} is higher or lower than the predetermined threshold voltage.

One problem with the above method is that although it accepts a wide input voltage range, it will output 2 voltage levels. However, in our application, we require that the method to be used with outputs voltage levels below a pre-determined maximum voltage level. That is, below the said pre-determined voltage level, the output may follow the input voltage level.

Therefore a new control circuit is required to deal with the condition when battery voltage is below 4.5V. In this invention, a novel power supply select control circuit is implemented to solve the above-mentioned limitation.

### SUMMARY OF THE INVENTION

The present invention is implemented to allow low voltage circuits to operate in wide voltage range of power supplies, including at very low supply voltages of below 4.5V. Besides the normal clamped step down voltage circuit, the invention circuit further comprises of a control circuit, high voltage PMOS, as well as some control signals, thus forming a power supply select control system that automatically selects a power supply source path to provide sufficient current at very low supply voltages of below 4.5V.

### BRIEF DESCRIPTION OF THE DRAWINGS

FIG. 1 is an exemplary embodiment of a prior art.

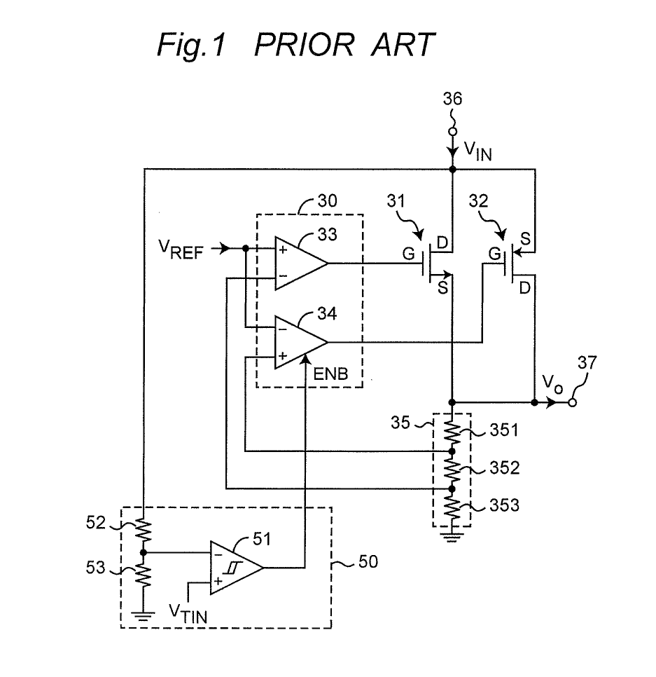

FIG. 2 is a power supply select block diagram according to a first embodiment.

FIG. 3 is a power supply select block diagram according to a second embodiment.

FIG. 4 is a circuit diagram of Control Circuit 112 shown in FIG. 3.

FIG. 5 is a graph showing a hysteresis effect in circuit.

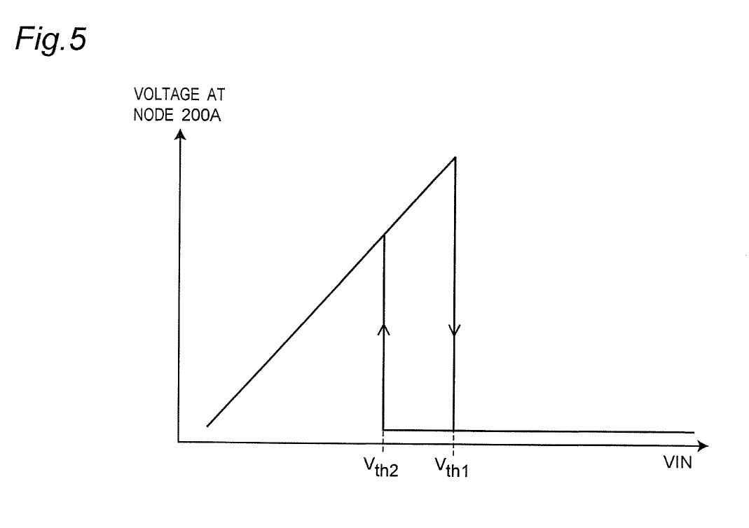

FIG. 6 is a graph showing a relationship between VCC2 and VIN.

### DETAILED DESCRIPTION OF THE PREFERRED EMBODIMENTS

### First Embodiment

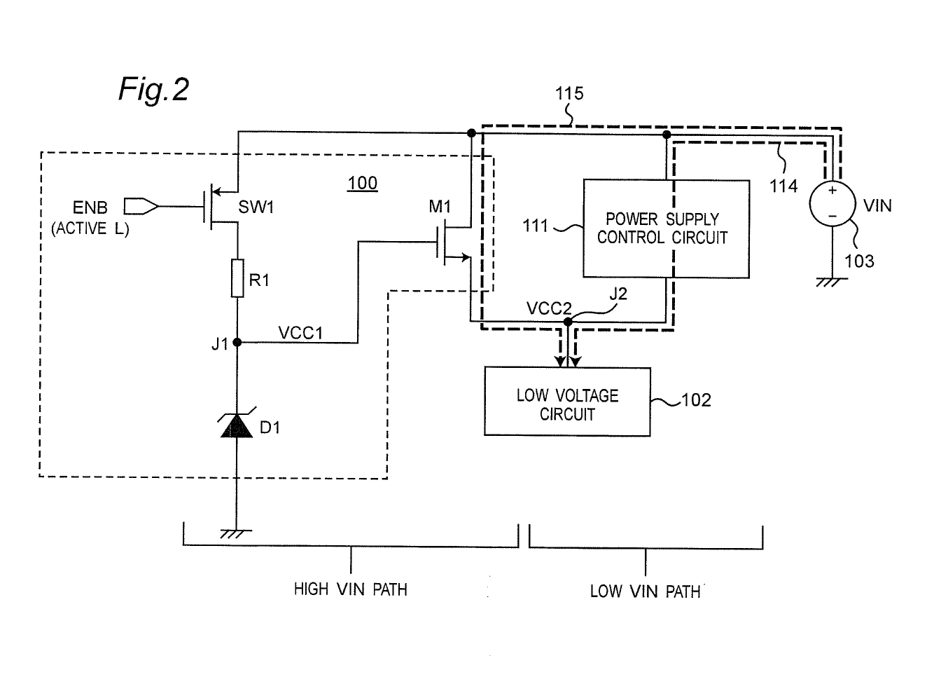

FIG. 2 shows a first embodiment of the power supply select control circuit according to the present invention. Based on an exemplary implementation of the present invention, two current paths are implemented to a low voltage circuit 102, namely a High VIN path 115 and a Low VIN path 114. As the name suggests, under normal operating conditions or when the voltage level VIN of input voltage source 103 is high, power supply to the low voltage circuit 102 will be from a clamped step down circuit 100, that is, via the High VIN path 115. The composition and operation of the clamped step down circuit 100 is described as follows:

The clamped step down circuit 100 includes a PMOS transistor SW1, an enable control pin ENB, a zener diode D1, an NMOS transistor M1 and a resistor R1. The input voltage source 103, which provides power to the low voltage circuit 102 via means external to the circuit, may vary in its voltage level VIN amplitude. However, for the purpose of explanation of this invention, the voltage level VIN of the input voltage source 103 may be in the range of typically 3V to 20V. The resultant voltage VCC2 at node J2 will then be supplied to the low voltage circuit 102.

When PMOS transistor SW1 is turned on, node J1, at which the voltage is VCC1, will be clamped at voltage V_{D} when the following condition is satisfied:

VIN≧V_{D}+V_{R1}+V_{SW1}

### Where:

V_{D} is the voltage across the zener diode D1;

V_{R1}=voltage across resistor R1; and

V_{SW1}=voltage difference across the source and drain terminals of PMOS transistor SW1.

Node J1 is connected to the cathode terminal of zener diode D1.

The purpose of resistor R1 is to ensure that zener diode D1 is able to clamp the voltage at V_{D}; otherwise, the voltage VCC1 at node J1 will follow the voltage level VIN of input voltage source 103, without any clamping effect. Note that the resistance of resistor R1 cannot be too large as it will limit the current, thus causing the zener diode D1 to not work.

The function of the enable control pin ENB shall be described as follows: When a logic LOW signal is inputted into the enable control pin ENB, PMOS transistor SW1 conducts, allowing zener diode D1 to turn on, resulting in the High VIN path to be in operating mode. Whereas, when a logic HIGH signal is inputted, PMOS transistor SW1 turns off, resulting in the High VIN path to be in standby mode.

The voltage VCC1 at node J1 will then be stepped down at transistor M1 by 1 V_{GS}. Subsequently, the stepped down voltage VCC2 at node J2 will then become the supply line to the low voltage circuit 102.

However, when the voltage level VIN of input voltage source 103 is low, power supply to the low voltage circuit 102 will be from a power supply control circuit 111, that is, via the Low VIN path 114. For the purpose of explanation, clamped step down circuit 100 and power supply control circuit 111 are arranged such that the High VIN path 115 is used when the voltage level VIN from the voltage source 103 is of amplitude 4.5V or higher, and the Low VIN path 114 is used when the voltage level VIN from the voltage source 103 is of amplitude lower than 4.5V.

The operation of the Power supply control circuit 111 is described as follows:

Upon detection of the voltage level of voltage source 103 being less than 4.5V, the Low VIN path 114 will be activated. To supply sufficient current to the low voltage circuit 102, the power supply control circuit 111 allows an alternative path that still couples to the voltage source 103, but with higher current source capability at lower voltage level of the voltage source 103.

Node J2 is the common output node which is shared by the clamped step down circuit 100 and the power supply control circuit 111. Hence, for both the High VIN path 115 and the Low VIN path 114, the current supply to the low voltage circuit 102 is via coupling of the node J2.

### Second Embodiment

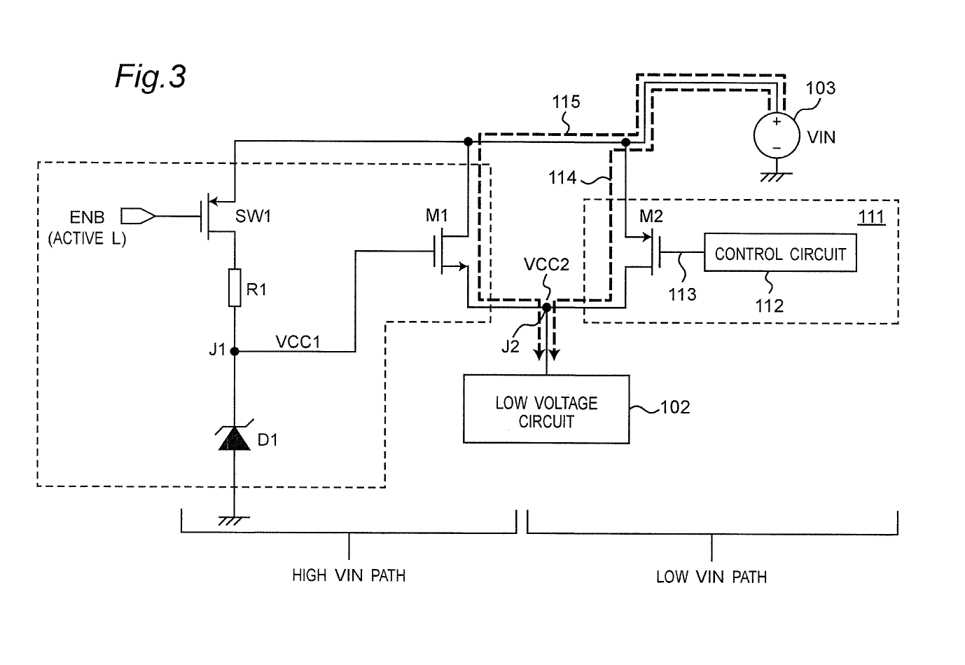

FIG. 3 shows a second embodiment of the present invention. This is an exemplary implementation of the power supply control circuit 111. The present embodiment comprises the following elements:
A PMOS transistor M2; and
A control circuit 112.

The output 113 of a control circuit 112 is used to control the PMOS transistor M2, which will be turned on when the voltage level VIN of the input voltage source 103 is lower than 4.5V. PMOS transistor M2 acts as a switch that enables coupling between the input voltage source 103 and the low voltage circuit 102. This is an exemplary implementation of the Low VIN path 114. In the present invention, PMOS transistor M2 is used in the explanation, but it is understood that PMOS transistor may be substituted by any switch means, for example a PNP transistor or others.

On the contrary, when the voltage level VIN of voltage source 103 is higher than 4.5V, the control circuit 112 is designed such that path 114 will be switched off. Hence only path 115 supplies current to the low voltage circuit 102. By doing this, the capability to supply current to low voltage circuit 102 is increased even after the voltage level VIN of the input voltage source 103 being lower than 4.5V.

Thus, in summary, the control circuit 112 performs the following functions:
To monitor the voltage level of the input voltage source 103;
To activate Low VIN path 114 upon detection of VIN<4.5V; and
To deactivate the Low VIN path 114 upon satisfying the condition of VIN≧4.5V.

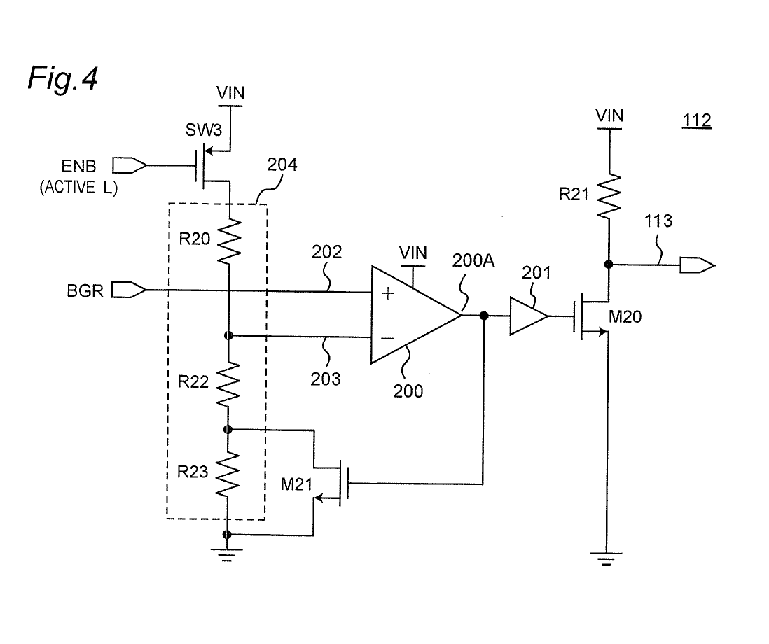

An exemplary implementation of the control circuit 112 is as shown in FIG. 4.

As shown in FIG. 4, a control switch SW3, such as a PMOS transistor, is provided. The enable control signal pin ENB, is coupled to the gate terminal of PMOS transistor SW3 of control circuit 112, in a manner similar to that described in connection with FIG. 2. When a logic LOW signal is inputted into the enable control signal pin ENB pin, PMOS transistor SW3 turns on, turning on a resistor network 204 and hence enabling the operation of the control circuit 112. On the other hand, if ENB pin is HIGH, the circuit will be in a standby mode.

The resistor network 204 comprising resistors R20, R22 and R23, is used to monitor the voltage level VIN of the input voltage source 103. Here, the voltage level VIN is voltage-divided via the voltage divider formed by the resistor network 204. The voltage-divided output, which is observed at node 203, is compared with a band-gap reference voltage BGR by a comparator 200. Node 203, the output from resistor network 204, and node 202, band-gap reference voltage BGR are applied to the comparator 200 at which a decision whether to turn on the Low VIN path 114, or not, is made. The band-gap reference voltage BGR is an internally generated voltage reference source or may be obtained from external voltage reference sources. Also, in the case of external band-gap reference source, the amplitude of the band-gap reference voltage BGR is pre-determined based on the selection of values for the resistor network 204; whereas for internally generated reference voltage BGR, the resistances of resistor network 204, are designed based on internally generated reference voltage BGR.

$$\begin{matrix}Node 203 = VIN [ R 22 / ( R 22 + R 20 ) ] OR \\ = VIN [ ( R 22 + R 23 ) / ( R 22 + R 23 + R 20 ) ]\end{matrix}$$

For the purpose of explanation, the inputs to the comparator 200 are arranged so that a HIGH signal is outputted at output 200A when the voltage-divided value of VIN at node 203 is lower than the band-gap reference voltage BGR, i.e., at the instance when VIN<4.5V. However, alternatively, the inputs to the comparator may be arranged so that a LOW signal is outputted at node 200A at the instance when VIN>=4.5V, depending on the user's preference.

The output 200A of comparator 200 is applied through a buffer 201 to NMOS transistor M20. Buffer acts to delay the output signal at output 200A, such that the signal at output 200A is first applied to the gate terminal of NMOS transistor M21 before being applied to the gate terminal of NMOS transistor M20. The NMOS transistors M20 and M21 function as switches. Hence, in place of the NMOS transistor, any alternative form of switches that may be fabricated in integrated circuit form is deemed suitable, for example an NPN transistor and others.

As the voltage level VIN increases gradually from a low voltage level (<4.5V) to a high voltage level (>4.5V), initially, node 203 is lower than node 202. This results in the signal at output 200A of comparator 200 being at logic HIGH. The logic HIGH signal will switch on the transistor M21, thus causing resistor R23 to be bypassed or shortcircuited. Resistor R23 is referred to as an adjusting resistor. Therefore the lower part of the resistor network 204 becomes effectively R22.

The threshold voltage of voltage level VIN at which the signal at output 200A switches from logic HIGH to logic LOW is denoted by Vₜₕ₁. For Vₜₕ₁, the logic HIGH to logic LOW transition is thus determined by

{VIN*[R22/(R22+R20)]}.

On the other hand, as the voltage level VIN decreases gradually from a high voltage level (>4.5V) to a low voltage level (<4.5V), initially, node 203 is higher than node 202. This results in the signal at output 200A of comparator 200 being at logic LOW. The logic LOW signal turns off the transistor M21. This will result in the lower part of the resistor network 204 to be effectively (R22+R23).

The threshold voltage of the voltage level VIN at which the signal at output 200A switches from logic LOW to logic HIGH is denoted by Vₜₕ₂. For Vₜₕ₂, the logic LOW to logic HIGH transition is thus determined by

{VIN*[(R22+R23)/(R22+R23+R20)]}.

As described in the above explanation, the main function of M21 is to change the resistance at the resistor network 204. By doing so, the threshold voltages when the voltage level VIN ramps up (low to high) and when the voltage level VIN ramps down (high to low) are different. The difference between these two threshold voltages is called hysteresis. Delay plays an important role in hysteresis function, because switch M21 has to be activated before M20 to avoid noise chattering. If delay is not implemented, before hysteresis function can be turned on, the control signal 200A is immediately applied to switch M20. Consequently, chattering may occur if the noise at the voltage level VIN is large to be detected.

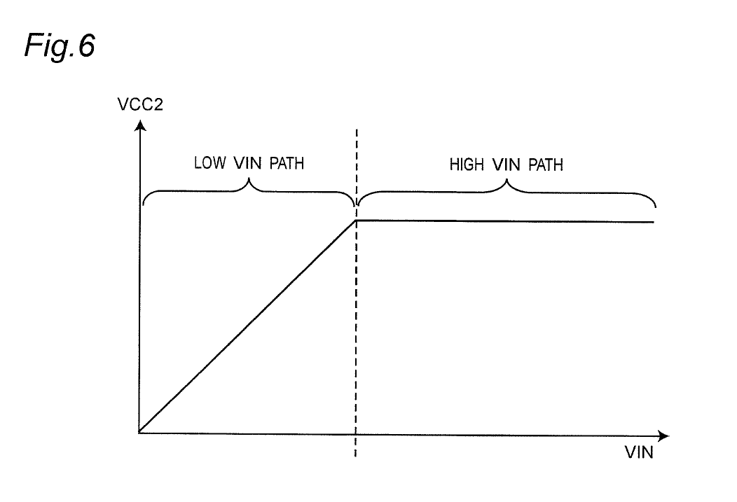

Node 113 is used to switch on and off PMOS transistor M2 (see FIG. 3) which subsequently resulting in the turning on and off of low VIN path 114 depending on the threshold voltage mentioned above. Before clamped step down power supply circuit is able to function and supply sufficient current to the Low Voltage Circuit 102 through High VIN path 115, Low VIN path 114 is turned on. The characteristic of the new invention circuit can be summarized in FIG. 6 which shows the characteristic of VCC2 vs VIN. As a result, the new invention power supply control circuit works in a complementary fashion with the clamped step down circuit.

1. An apparatus for selecting a path from a voltage source to a low voltage circuit, comprising:
a clamped step down circuit operable to select a first power supply path when a voltage level from the voltage source is above or equal to a pre-determined voltage level; and
a power supply control circuit operable to select a second power supply path when the voltage level from the voltage source is below the pre-determined voltage level.

2. The apparatus based on claim 1, wherein said clamped step down circuit comprises:
a first PMOS transistor;
an enable control pin that accepts a signal for turning on or off said first PMOS transistor;
a zener diode;
a first NMOS transistor; and
a first resistor.

3. The apparatus based on claim 2, wherein said power supply control circuit comprises:
a first switch operable to couple said voltage source with said low voltage circuit; and
a control circuit operable to control said first switch.

4. The apparatus based on claim 3, wherein said first switch is a PMOS transistor.

5. The apparatus based on claim 3, wherein said switch is a PNP transistor.

6. The apparatus based on claim 3, wherein said switch is a switch implemented in an integrated circuit form.

7. The apparatus based on claim 3, wherein said control circuit is implemented in an integrated circuit form.

8. The apparatus based on claim 7, wherein said control circuit comprises:
a resistor network operable to divide the input voltage source level and to produce a divided voltage, said resistor network having an adjusting resistor;
a reference voltage source operable to supply a reference voltage;
a comparator operable to compare said divided voltage with said reference voltage; and
a second switch operable to shortcircuit said adjusting resistor;
wherein said shortcircuit resistor having a first terminal coupled to a first terminal of said second switch and having a second terminal coupled to a second terminal of said second switch.

9. The apparatus based on claim 8, wherein said second switch is an NMOS transistor.

10. The apparatus based on claim 8, wherein said second switch is an NPN transistor.

11. The apparatus based on claim 8, wherein said control circuit further comprises:
a buffer operable to delay the signal outputted from the said comparator; and
a third switch operable to produce ON and OFF signals based on the delayed signal.

12. The apparatus based on claim 11, wherein said third switch is an NMOS transistor.

13. The apparatus based on claim 11, wherein said third switch is an NPN transistor.

14. A method of selecting a path from a voltage source to a low voltage circuit, comprising:
selecting a first power supply path when a voltage level from the voltage source is above or equal to a pre-determined voltage level; and
selecting a second power supply path when the voltage level from the voltage source is below the pre-determined voltage level.

15. The method based on claim 14, further comprising:
detecting when the said input voltage source level is below the pre-determined voltage level.
